(19) United States
(12) Patent Application Publication
(10) Pub. No.: US 2014/0322421 A1
(43) Pub. Date: Oct. 30, 2014

(54) METHOD FOR PRODUCING COOKED AND FROZEN PASTA

(71) Applicant: NISSHIN FOODS INC., Chiyoda-ku, Tokyo (JP)

(72) Inventors: Kentarou Irie, Fujimino-shi (JP); Youhei Suga, Fujimino-shi (JP); Norio Koizumi, Fujimino-shi (JP); Takenori Watanabe, Fujimino-shi (JP); Youichirou Miya, Fujimino-shi (JP); Tsuguhiko Yoshida, Chiyoda-ku (JP)

(73) Assignee: NISSHIN FOODS INC., Chiyoda-ku, Tokyo (JP)

(21) Appl. No.: 14/364,488

(22) PCT Filed: Dec. 21, 2012
(86) PCT No.: PCT/JP2012/083209

§ 371 Date: Jun. 11, 2014

(30) Foreign Application Priority Data
May 14, 2012 (JP) 2012-110188
May 31, 2012 (CN) 201210174977.6

(51) Int. Cl. A23L 1/16

(52) U.S. Cl. CPC A23L 1/1613
USPC 426/557

(57) ABSTRACT

Cooked and frozen pastas which can be stored in a frozen state for a long time and which retain good appearance and texture comparable to freshly boiled fresh pastas even after being thawed are provided. A method for producing the cooked and frozen pastas, comprising the steps of boiling fresh pastas obtained by extruding dough into pasta noodles at a pressure of from 80 kgf/cm² to 200 kgf/cm², bringing the resulting boiled pasta into contact with a liquid comprising an oil or fat having a melting point of 10° C. or less, and then freezing the pasta which has been brought into contact with the liquid.

### TECHNICAL FIELD

The present invention relates to a method for producing cooked and frozen pastas. In more detail, the present invention relates to a method for producing cooked and frozen pastas which can be stored for a long time in a state such that the pastas is cooked by boiling fresh pasta noodles, followed by freezing, and which retain good appearance and texture comparable to freshly boiled fresh pasta even after being thawed.

### BACKGROUND ART

Fresh pastas refer to pastas which are produced from dough without going through a drying step. Fresh pastas are different foods from dried pastas in terms of production steps as well as product appearance. Also, fresh pastas are popular foods because they attain a unique, soft yet elastic texture after they are boiled. However, because fresh pastas have poor storage stability due to high water content, they have a problem that they cannot be cooked in advance. Fresh pastas in a chilled or frozen state are commercially available. However, it is difficult to maintain good appearance and texture of freshly produced fresh pastas because chilled- or frozen-stored fresh pastas are prone to quality deterioration during storage. Further, when pastas obtained by cooking fresh pastas are chilled- or frozen-stored with sauce on top, quality is deteriorated. For example, the sauce penetrates into the pasta during storage, resulting in an exceedingly soft texture.

Fresh pastas which can be stored for a long time have already been proposed before. For example, Patent Literature 1 describes a method for producing quickly-rehydratable fresh pastas having storage stability, comprising drying dough, which has been extruded out at a specific pressure under specific vacuum conditions, to certain water content, and then sealing and sterilizing the dough. However, because the above fresh pastas have been subjected to a drying process, they have a similar texture to that of boiled dried pasta, failing in providing a satisfactory soft and elastic texture unique to fresh pastas.

Patent Literature 2 describes a method, comprising frozen-storing semi-fresh pasta, which has been boiled and cooked, and cooking the pasta with water in a microwave oven before serving. However, because pastas provided by the above cooking method are semi-cooked pasta prepared by boiling dried pasta, they have a completely different texture from so-called boiled fresh pasta prepared by boiling fresh state.

Patent Literature 3 describes a method for producing fresh noodles with excellent storage stability, comprising kneading wheat flour or wheat semolina, activated gluten powder and/or egg white with water, and then subjecting the resulting mixture to extrusion under reduced pressure. However, although the resulting fresh noodles had a good appearance, they were unsatisfactory in terms of storage stability.

Patent Literature 4 describes pasta, characterized by subjecting dough which has been kneaded under reduced pressure and then extrusion into chips, to further kneading and extrusion. However, because this pasta was intended to provide less stickiness and excellent smoothness and hardness with adequate elasticity by diversifying the direction of the gluten network of the dough, two extrusion steps were necessary, resulting in the pasta having a very hard texture lacking a chewy and resilient (mochimochi) texture.

In light of the above, in a practical situation, there is a demand for cooked pastas which can be stored in a frozen state for a long time, while maintaining a unique soft yet elastic texture of boiled fresh pasta even after frozen-storage.

### CITATION LIST

### Patent Literature

[Patent Literature 1] JP-B-S63-32424
[Patent Literature 2] JP-A-H10-295302
[Patent Literature 3] JP-A-2001-245617
[Patent Literature 4] JP-A-2001-346533

### SUMMARY OF INVENTION

### Technical Problem

In light of the practical situation described above, an object of the present invention is to provide cooked and frozen pastas which can be stored in a frozen state for a long time and which retain good appearance and texture comparable to freshly boiled fresh pastas even after being thawed.

### Solution to Problem

The present inventors conducted various studies to achieve the aforementioned object. As a result, they found that cooked and frozen pastas which were produced by boiling fresh pasta obtained by extruding dough into pasta noodles at a specific pressure attaching a liquid comprising an oil or fat having a melting point of 10° C. or less to the boiled pasta, and then freezing the resulting pasta are highly resistant to freezing, and thus can be stored in a frozen state for a long time while presenting good appearance and texture comparable to freshly boiled fresh pasta after being thawed, thereby completing the present invention.

That is, the present invention provides a method for producing cooked and frozen pastas, comprising steps of boiling fresh pastas obtained by extruding dough into pasta noodles at a pressure of from 80 kgf/cm² to 200 kgf/cm², bringing the boiled pasta into contact with a liquid comprising an oil or fat having a melting point of 10° C. or less, and then freezing the pasta which has been brought into contact with the liquid.

### Advantageous Effects of Invention

In the cooked and frozen pastas obtained by the production method of the present invention, the water and oil are prevented from moving during freezing or thawing. Thus, the cooked and frozen pastas obtained by the production method of the present invention are highly resistant to freezing and can maintain favorable appearance even after long-term frozen storage, and after being thawed, they can retain good appearance and texture as obtained when conventional fresh pastas are consumed immediately after being boiled. Moreover, since deterioration of appearance and texture of pasta caused by the absorption of sauce is prevented in the cooked and frozen pastas obtained by the production method of the present invention, even when they are frozen-stored with sauce on top, good quality can be maintained.

### DESCRIPTION OF EMBODIMENTS

In general, fresh pastas are produced by rolling out noodle dough while applying pressure and cutting out the resulting dough into noodles or by extruding noodle dough while applying pressure in accordance with various noodle production methods such as rolling, rolling, and extruding. However, in either case, noodle production was not carried out under high pressure because there was no need to dry noodles according to conventional production methods of fresh pasta, and the unique texture of dried pastas was not necessary. According to conventional production methods of fresh pastas, pressure applied to noodle dough during noodle production is approximately 0 kgf/cm² in the case of rolling, and it is approximately 20 kgf/cm² even in the case of extrusion.

However, fresh pastas used in the method for producing cooked and frozen pastas according to the present invention is prepared by applying, to dough, such an unusually high pressure as a pressure to be applied to fresh pastas. For example, fresh pastas used in the production method of the present invention can be prepared by extruding dough into noodles at a pressure of from 80 kgf/cm² to 200 kgf/cm². The extrusion pressure is equal to or higher than the extrusion pressure normally used in the production of dried pasta (approximately from 70 to 160 kgf/cm²), and is extremely high as a pressure to be applied to fresh pastas.

Dough for fresh pastas used in the production method of the present invention is noodle dough obtained by adding kneading water to 100% wheat flour or a flour ingredient containing wheat flour as the main component, followed by kneading. Wheat flour used for the aforementioned flour ingredient is not particularly limited as long as it is one that can be used for pastas, and examples thereof include wheat flour such as hard wheat flour, semi-hard wheat strong flour, moderate wheat flour, soft wheat flour, and durum wheat flour, and semolina wheat flour such as durum semolina. These flours can be used singly or in combinations of two or more thereof.

As the aforementioned wheat flour, it is preferable to use a mixture of durum wheat flour and regular wheat flour other than durum wheat flour since the chewy and resilient (mochimochi) texture of the pasta obtained can be improved compared to that obtained by use of durum wheat flour alone. Examples of the regular wheat flour include hard wheat flour, semi-hard wheat flour, moderate wheat flour, soft wheat flour, and a mixture of these flours, among which moderate wheat flour is preferable.

Alternatively, it is preferable to further blend, in addition to the aforementioned wheat flour, starch or processed starch in the aforementioned flour ingredient of dough of fresh pastas since the texture of the pasta obtained can be further improved. Examples of the starch include one which can be normally used in pastas such as tapioca starch, potato starch, wheat starch, corn starch, and waxy corn starch. Examples of the processed starch include one obtained by subjecting the above starch to processing such as acetylation, hydroxypropylation, etherification, cross-linking, oxidation, and pregelatinization or by physical treatment. The aforementioned starches and processed starches can be used singly or in combinations of two or more thereof. Among the aforementioned starches and processed starches, hydroxypropylated starch is preferable since it improves the chewy and resilient (mochimochi) texture of pasta.

The aforementioned flour ingredient of dough of fresh pastas preferably contains durum flour and at least one selected from the group consisting of starch, processed starch, and regular wheat flour. The flour ingredient more preferably contains durum wheat flour, regular wheat flour, and at least one selected from the group consisting of starch and processed starch. The blending ratio of durum wheat flour to at least one selected from the group consisting of starch, processed starch and regular wheat flour in the flour ingredient is preferably 30:70 to 95:5, more preferably 60:40 to 90:10.

In addition to the aforementioned wheat flour, starches, and processed starch, other ingredients normally used for the production of fresh pastas such as sugars, gluten, eggs, salt, oil and fat, emulsifiers, and thickeners can be added to the aforementioned flour ingredient. The amount of these other ingredients added may be from 0 to 30 parts by mass relative to 100 parts by mass of the aforementioned wheat flour, starches and processed starch.

As the kneading water used for the production of dough, any kind of water used for routine noodle production such as of water, salt water, and lye water can be used. Considering that the dough obtained is subjected to such a high extrusion pressure as described above, the amount of kneading water added is preferably from 18 to 35 parts by mass, more preferably from 20 to 30 parts by mass, and even more preferably from 24 to 27 parts by mass relative to 100 parts by mass of the flour ingredient. When the amount of kneading water added is less than 18 parts by mass, the extruded noodle strands become fragile and easily fragmented. On the other hand, when the amount of kneading water added exceeds 35 parts by mass, the dough becomes weak and susceptible to damage, resulting in failure of the fresh pastas thus obtained to achieve the desired appearance or texture.

In the present invention, fresh pastas are obtained by producing noodles using the aforementioned dough under high pressure. That is, fresh pastas used in the method of the present invention may be produced by extruding the above dough into noodles at a pressure of, for example, from 80 kgf/cm² to 200 kgf/cm², preferably from 120 to 160 kgf/cm². The degree of pressure reduction during extrusion may be from −200 mmHg to vacuum, preferably from −600 mmHg to vacuum. The extrusion can be carried out by using, for example, an extrusion noodle making machine used for the production of dried pasta. According to the present method, in the preparation process of the fresh pasta, noodles may be prepared by extruding dough which has been obtained by kneading the ingredients; therefore, the kneading step and the noodle preparation-by-extrusion step may each be performed once. According to the present method, in the preparation process of the fresh pasta, the kneading step and the noodle preparation-by-extrusion step need not be performed twice or more, meaning that the dough made into noodles needs not be kneaded again or subjected to another noodle preparation process.

In the present invention, the shape of the fresh pastas is not particularly limited, and after extruding dough into noodle sheets, they can be made into the desired shape such as noodle strands by, for example, compression flattening and cutting in accordance with a routine method. Alternatively, pastas can be made into the desired shape by extruding dough through a die having openings of appropriate shape.

In the production method of the present invention, the fresh pastas obtained according to the above procedure are directly boiled without being subjected to a drying step, etc. Boiling can be performed by a regular boiling method used for fresh pasta. In general, fresh pastas are cooked in boiling water for two to eight minutes. After optionally draining hot water, the pastas are cooled.

Subsequently, the pastas boiled as described above are brought into contact with a liquid comprising an oil or fat having a melting point of 10° C. or less. The kind of the oil or fat having a melting point of 10° C. or less is not particularly limited as long as the oil or fat is an edible oil having a melting point of 10° C. or less, preferably 3° C. or less. Examples thereof include soybean oil, corn oil, canola oil, olive oil, sesame oil, and a mixed oil or fat thereof. Among them, soybean oil is preferable. Alternatively, the oil or fat having a melting point of 10° C. or less can be a mixed oil or fat in which an oil or fat having a higher melting point and an oil or fat having a lower melting point are mixed in such a way as to achieve a certain melting point. In the present specification, the melting point of an oil or fat refers to the slipping point described in 2.2.4.2-1996 of Kijun yushi bunseki shikenho (or its English version, “The JOCS Standard Methods for the Analysis of Fats, Oils and Related Materials”, First English Edition, 2009, Japan Oil Chemists' Society).

The aforementioned liquid comprising an oil or fat having a melting point of 10° C. or less may contain, in addition to the aforementioned oils and fats, water, an emulsifier, a thickener, and the like. Examples of the thickener include gums such as xanthan gum, tamarind gum, and guar gum, polysaccharides such as carrageenanand agar, hyaluronic acid, alginic acid and the like. Among them, xanthan gum is preferable. The content of the oil or fat having a melting point of 10° C. or less in the aforementioned liquid is 5% by mass or more, preferably from 10 to 95% by mass.

As a means for bringing the aforementioned liquid comprising an oil or fat having a melting point of 10° C. or less with the aforementioned boiled pastas, a means enabling the liquid to attach to the entire surface of the pasta is preferable, and examples of such a means include spraying, spreading, and immersing. Among them, in terms of economic efficiency and convenience, spraying is preferable. The amount of the liquid attahced to the pasta surface may be from 1 to 12 parts by mass, preferably from 3 to 8 parts by mass relative to 100 parts by mass of the boiled pasta. When the attached amount is less than 1 part by mass, the resulting fresh pasta has exceedingly soft texture, while when the attached amount exceeds 12 parts by mass, the resulting fresh pasta has oily texture.

Subsequently, the aforementioned boiled pastas which have been brought into contact with the liquid comprising an oil or fat having a melting point of 10° C. or less are subjected to a freezing process. For the freezing process in the production method of the present invention, a freezing process routinely performed on noodles can be adopted. For example, it is preferable that the pastas described above be divided into certain portions, for example, 150 to 300 g for one person, and served on trays, etc., and then subjected to freezing process. For the freezing process, either quick freezing or slow freezing may be feasible; however, quick freezing is preferable. Once the pastas are frozen by quick freezing, they can be stored under normal frozen-storage conditions.

In the aforementioned freezing process, the pastas described above may be frozen with sauce. For example, sauce may be poured on top of the pastas after dividing, into trays or the like, the pasta which has been boiled and attached with the liquid comprising an oil or fat having a melting point of 10° C. or less, as described above and the resultant pastas are frozen: or sauce may be mixed with the pastas and the resultant pastas are served on trays, and then frozen. As the sauce, any regular pasta sauce may be used, and examples thereof include a tomato-based sauce such as meat sauce, Neapolitan sauce, and arrabbiata sauce, a white sauce such as carbonara sauce, and a brown sauce; however, the sauce is not limited to these examples.

Compared to conventional frozen product of fresh pastas or boiled fresh pastas, the water and oil are further prevented from moving during freezing or thawing in the cooked and frozen pastas produced in accordance with the production method of the present invention. Thus, the above cooked and frozen pastas are highly resistant to freezing and maintain good appearance even after long-term frozen storage. Further, the above cooked and frozen pastas present good appearance and texture comparable to those provided by freshly boiled fresh pastas even after being thawed or re-heated. Also, since deterioration of appearance and texture of pasta caused by the absorption of sauce is inhibited in the above cooked and frozen pastas, even when they are frozen-stored with sauce on top, good quality can be maintained.

### EXAMPLES

Hereinbelow, the present invention will be further described in detail with reference to Examples. However, the present invention is not limited to these Examples.

### Production Examples 1 to 8

Durum wheat semolina flour (Leone G: the product of Nisshin Flour Milling Inc.) (100 parts by mass) and water (26 parts by mass) were mixed and then kneaded to prepare noodle dough. Under a reduced pressure condition of −600 mmHg, the dough was extruded into noodles by a pasta making machine under each of the following pressure conditions of 30, 70, 80, 120, 160, 200, 210, and 250 kgf/cm², whereby eight kinds of fresh spaghetti (1.8 mm in diameter) were obtained.

The fresh spaghetti thus obtained was boiled in hot water for five minutes and then cooled with water, whereby boiled spaghetti was produced.

Thirty parts by mass of soybean oil (melting point −7° C.) and 0.2 part by mass of a polysaccharide thickener were mixed, and to the resulting mixed liquid, 5 parts by mass of water was further added, followed by mixing, whereby a coating liquid was prepared. Subsequently, using a spray, the aforementioned coating liquid was sprayed to the entire spaghetti, in an amount of 5% by mass of the mass of the boiled spaghetti, whereby the total amount of the coating liquid was allowed to attach to the boiled spaghetti.

The boiled spaghetti attached with the coating liquid was divided into trays (160 mm×120 mm; made of polypropylene) at 180 g per tray, and further, for half of the trays, 100 g of commercially available canned meat sauce (the product of Nisshin Foods Inc.) was poured on top of the noodle mass. The resulting spaghetti was quickly frozen at −35° C., whereby the cooked and frozen spaghetti of Production Examples 1 to 8 (each with and without sauce) were produced.

### Production Example 9

The aforementioned noodle dough was rolled out using a noodle maker roller machine (pressure, 0 kgf/cm²) and then cut, whereby fresh spaghetti (1.8 mm in diameter) was obtained. In a similar procedure to Production Example 1, the fresh spaghetti thus obtained was boiled, attached with the coating liquid, and frozen, whereby the cooked and frozen spaghetti of Production Example 9 (with and without sauce) was produced.

### Test Example 1

The cooked and frozen spaghetti of Production Examples 1 to 9 was removed from the trays, packed in polypropylene bags, and then stored at −18° C. After one week, the frozen spaghetti was removed from the bags and then thawed by heating in a microwave oven (600 W). Spaghetti without sauce was heated for three minutes, whereas spaghetti with sauce was heated for 4minutes and 30 seconds. The appearance and texture of the spaghetti after being thawed were evaluated. The spaghetti with sauce was lightly mixed after heating and the appearance and texture of the spaghetti with sauce were evaluated. Evaluation was conducted by 10 panelists based on the evaluation criteria shown in Table 1, and average scores were obtained. The results are shown in Table 2.

TABLE 1

| | | |
|---|---|---|
| Appearance of | 5 | Noodle surface is very smooth and shiny. |
| spaghetti | 4 | Noodle surface is fairly smooth and shiny. |
| | 3 | Noodle surface is relatively smooth |
| | | without roughness. |
| | 2 | Noodle surface is slightly rough or |
| | | melted. |
| | 1 | Noodle surface is rough or melted. |
| Texture of | 5 | Equivalent texture to boiled fresh |
| spaghetti | | spaghetti with adequate softness and |
| | | elasticity. |
| | 4 | Similar texture to boiled fresh spaghetti |
| | | with softness and elasticity. |
| | 3 | Slightly similar texture to boiled fresh |
| | | spaghetti with moderate softness and |
| | | elasticity. |
| | 2 | Slightly too soft or slightly too hard, |
| | | lacking the texture of boiled fresh |
| | | spaghetti. |
| | 1 | Too soft or too hard, lacking the texture |
| | | of boiled fresh spaghetti. |
| Appearance of | 5 | Sauce evenly clings to the entire noodles. |
| spaghetti | 4 | Sauce roughly evenly clings to the entire |
| with sauce | | noodle. |
| | 3 | Sauce slightly unevenly clings to noodles. |
| | 2 | Sauce poorly or unevenly clings to |
| | | noodles. |
| | 1 | Sauce very poorly and unevenly clings to |
| | | noodles. |
| Texture of | 5 | Noodles are sufficiently soft and elastic |
| spaghetti | | and harmonized with sauce. Excellent |
| with sauce | | texture. |
| | 4 | Noodles are soft and elastic and |
| | | harmonized with sauce. Good texture. |
| | 3 | Noodles are relatively soft and elastic. |
| | | Average texture. |
| | 2 | Noodles are slightly too soft or slightly |
| | | too hard with absorption of a small amount |
| | | of sauce. Slightly poor texture. |
| | 1 | Noodles are too soft or too hard with |
| | | absorption of a large amount of sauce. |
| | | Poor texture. |

TABLE 2

| | Produc- | Produc- | Produc- | Produc- | Produc- | Produc- | Produc- | Produc- | Produc- |
|---|---|---|---|---|---|---|---|---|---|
| | tion | tion | tion | tion | tion | tion | tion | tion | tion |
| | Example | Example | Example | Example | Example | Example | Example | Example | Example |
| | 1 | 2 | 3 | 4 | 5 | 6 | 7 | 8 | 9 |
| Extrusion | 30 | 70 | 80 | 120 | 160 | 200 | 210 | 250 | 0 |
| pressure | | | | | | | | | |
| (kgf/cm²) | | | | | | | | | |
| Appearance of | 2.8 | 3.5 | 4.3 | 4.8 | 4.9 | 4.6 | 4.1 | 3.8 | 2.3 |
| spaghetti | | | | | | | | | |
| Texture of | 2.9 | 3.1 | 4.1 | 4.8 | 4.8 | 4.3 | 3.2 | 2.9 | 2.0 |
| spaghetti | | | | | | | | | |
| Appearance of | 2.7 | 3.4 | 4.2 | 4.7 | 4.6 | 4.3 | 3.9 | 3.7 | 2.1 |
| spaghetti | | | | | | | | | |
| with sauce | | | | | | | | | |
| Texture of | 3.1 | 3.4 | 4.1 | 4.5 | 4.6 | 4.4 | 3.3 | 3.0 | 2.0 |
| spaghetti | | | | | | | | | |
| with sauce | | | | | | | | | |

### Production Examples 10 to 17

Except for adding water in amounts shown in Table 3 to 100 parts by mass of durum wheat semolina flour (Leone G: manufactured by Nisshin Flour Milling Inc.), the cooked and frozen spaghetti of Production Examples 10 to 17 (each with and without sauce) were produced by the same procedure as in Production Example 5 (noodle extrusion pressure: 160 kgf/cm²). Using the cooked and frozen spaghetti of Production Examples 10 to 17, the appearance and texture of the spaghetti or spaghetti with sauce after being thawed were evaluated by the same procedure as in Test Example 1. The results are shown in Table 3.

TABLE 3

| | Produc- | Produc- | Produc- | Produc- | Produc- | Produc- | Produc- | Produc- |
|---|---|---|---|---|---|---|---|---|
| | tion | tion | tion | tion | tion | tion | tion | tion |
| | Example | Example | Example | Example | Example | Example | Example | Example |
| | 10 | 11 | 12 | 13 | 14 | 15 | 16 | 17 |
| Water | 15 | 18 | 20 | 24 | 27 | 30 | 35 | 37 |
| (parts by | | | | | | | | |
| mass) | | | | | | | | |
| Appearance of | 3.1 | 4.2 | 4.5 | 4.8 | 4.9 | 4.6 | 4.3 | 3.7 |
| spaghetti | | | | | | | | |
| Texture of | 3.2 | 3.9 | 4.4 | 4.8 | 4.8 | 4.3 | 4.0 | 3.6 |
| spaghetti | | | | | | | | |
| Appearance of | 3.2 | 4.0 | 4.3 | 4.6 | 4.6 | 4.1 | 4.0 | 3.6 |
| spaghetti | | | | | | | | |
| with sauce | | | | | | | | |
| Texture of | 3.5 | 3.9 | 4.3 | 4.6 | 4.6 | 4.4 | 4.3 | 3.7 |
| spaghetti | | | | | | | | |
| with sauce | | | | | | | | |

### Production Examples 18 to 22

Except for changing the melting point of an oil or fat contained in the coating liquid as shown in Table 4, the cooked and frozen spaghetti of Production Examples 18 to 22 (each with and without sauce) were produced by the same procedure as in Production Example 5 (noodle extrusion pressure: 160 kgf/cm²). Using the cooked and frozen spaghetti of Production Examples 18 to 22, the appearance and texture of the spaghetti or spaghetti with sauce after being thawed were evaluated by the same procedure as in Test Example 1. The results are shown in Table 4.

TABLE 4

| | Produc- | Produc- | Produc- | Produc- | Produc- |
|---|---|---|---|---|---|
| | tion | tion | tion | tion | tion |
| | Example | Example | Example | Example | Example |
| | 18 | 19 | 20 | 21 | 22 |
| Melting point of | 0*¹⁾ | 3*²⁾ | 10*³⁾ | 15*⁴⁾ | 20*⁵⁾ |
| oil or fat | | | | | |
| (° C.) | | | | | |
| Appearance of | 4.9 | 4.7 | 4.4 | 3.1 | 2.8 |
| spaghetti | | | | | |
| Texture of | 4.8 | 4.3 | 4.0 | 2.4 | 2.2 |
| spaghetti | | | | | |
| Appearance of | 4.6 | 4.6 | 4.2 | 3.5 | 3.3 |
| spaghetti | | | | | |
| with sauce | | | | | |
| Texture of | 4.6 | 4.4 | 4.0 | 2.7 | 2.3 |
| spaghetti | | | | | |
| with sauce | | | | | |

*¹⁾Mixed oil of rapeseed oil and olive oil
*²⁾Olive oil
*³⁾Mixed oil of rapeseed oil and palm oil
*⁴⁾Mixed oil of rapeseed oil and palm oil
*⁵⁾Mixed oil of rapeseed oil and palm oil

### Production Examples 23 to 29

Except for changing the amount of the coating liquid attaching to the boiled spaghetti as shown in Table 5, the cooked and frozen spaghetti of Production Examples 23 to 29 (each with and without sauce) were produced by the same procedure as in Production Example 5 (noodle extrusion pressure: 160 kgf/cm²). Using the cooked and frozen spaghetti of Production Examples 23 to 29, the appearance and texture of the spaghetti or spaghetti with sauce after being thawed were evaluated by the same procedure as in Test Example 1. The results are shown in Table 5.

TABLE 5

| | Produc- | Produc- | Produc- | Produc- | Produc- | Produc- | Produc- |
|---|---|---|---|---|---|---|---|
| | tion | tion | tion | tion | tion | tion | tion |
| | Example | Example | Example | Example | Example | Example | Example |
| | 23 | 24 | 25 | 26 | 27 | 28 | 29 |
| Amount of coating | 0 | 0.5 | 1 | 3 | 8 | 12 | 15 |
| liquid attached | | | | | | | |
| (parts by mass | | | | | | | |
| relative to 100 | | | | | | | |
| parts by mass of | | | | | | | |
| boiled pasta) | | | | | | | |
| Appearance of | 3.5 | 3.9 | 4.3 | 4.8 | 4.8 | 4.4 | 4.0 |
| spaghetti | | | | | | | |
| Texture of | 3.3 | 3.8 | 4.2 | 4.7 | 4.8 | 4.5 | 3.8 |
| spaghetti | | | | | | | |
| Appearance of | 3.6 | 3.9 | 4.2 | 4.6 | 4.7 | 4.5 | 3.9 |
| spaghetti | | | | | | | |
| with sauce | | | | | | | |
| Texture of | 3.2 | 3.8 | 4.3 | 4.6 | 4.7 | 4.2 | 3.7 |
| spaghetti | | | | | | | |
| with sauce | | | | | | | |

### Production Examples 30 to 36

Except for adding durum wheat semolina flour (Leone G: the product of Nisshin Flour Milling Inc.) and hydroxypropylated starch (Yuri: the product of Matsutani Chemical Industry Co., Ltd.) in amounts shown in Table 6, the cooked and frozen spaghetti of Production Examples 30 to 36 (each with and without sauce) were produced by the same procedure as in Production Example 25 (water added: 26 parts by mass, noodle extrusion pressure: 160 kgf/cm2).

Using the cooked and frozen spaghetti of Production Examples 30 to 36, the appearance and texture of the spaghetti or spaghetti with sauce after being thawed were evaluated by the same procedure as in Test Example 1. The results are shown in Table 6. Also, the results of Production Example 25 are shown again in Table 6.

TABLE 6

| | Produc- | Produc- | Produc- | Produc- | Produc- | Produc- | Produc- | Produc- |
|---|---|---|---|---|---|---|---|---|
| | tion | tion | tion | tion | tion | tion | tion | tion |
| | Example | Example | Example | Example | Example | Example | Example | Example |
| | 30 | 31 | 32 | 33 | 34 | 35 | 36 | 25 |
| Durum semolina | 20 | 30 | 40 | 60 | 80 | 90 | 95 | 100 |
| flour (parts | | | | | | | | |
| by mass) | | | | | | | | |
| Hydroxypropylated | 80 | 70 | 60 | 40 | 20 | 10 | 5 | 0 |
| starch (parts by | | | | | | | | |
| mass) | | | | | | | | |
| Amount of coating | 1 | 1 | 1 | 1 | 1 | 1 | 1 | 1 |
| liquid attached | | | | | | | | |
| (parts by mass | | | | | | | | |
| relative to 100 | | | | | | | | |
| parts by mass of | | | | | | | | |
| boiled pasta) | | | | | | | | |
| Appearance of | 3.5 | 4.4 | 4.4 | 4.6 | 4.8 | 4.7 | 4.4 | 4.3 |
| spaghetti | | | | | | | | |
| Texture of | 3.7 | 4.3 | 4.4 | 4.5 | 5.0 | 4.9 | 4.3 | 4.2 |
| spaghetti | | | | | | | | |
| Appearance of | 3.4 | 4.4 | 4.4 | 4.5 | 4.6 | 4.3 | 4.3 | 4.2 |
| spaghetti | | | | | | | | |
| with sauce | | | | | | | | |
| Texture of | 3.3 | 4.4 | 4.5 | 4.6 | 4.9 | 4.8 | 4.4 | 4.3 |
| spaghetti | | | | | | | | |
| with sauce | | | | | | | | |

### Production Examples 37 to 43

Except for adding durum wheat semolina (Leone G: the product of Nisshin Flour Milling Inc.), hydroxypropylated starch (Yuri: the product of Matsutani Chemical Industry Co., Ltd.), and regular flour (Shirotsubaki: produced by Nisshin Flour Milling Inc.) in amounts shown in Table 7, the cooked and frozen spaghetti of Production Examples 37 to 43 (each with and without sauce) were produced by the same procedure as in Production Example 25 (water added: 26 parts by mass, noodle extrusion pressure: 160 kgf/cm²).

Using the cooked and frozen spaghetti of Production Examples 37 to 43, the appearance and texture of the spaghetti or spaghetti with sauce after being thawed were evaluated by the same procedure as in Test Example 1. The results are shown in Table 7. Also, the results of Production Example 25 are shown again in Table 7.

TABLE 7

| | Produc- | Produc- | Produc- | Produc- | Produc- | Produc- | Produc- | Produc- |
|---|---|---|---|---|---|---|---|---|
| | tion | tion | tion | tion | tion | tion | tion | tion |
| | Example | Example | Example | Example | Example | Example | Example | Example |
| | 37 | 38 | 39 | 40 | 41 | 42 | 43 | 25 |
| Durum semolina | 20 | 30 | 40 | 60 | 80 | 90 | 95 | 100 |
| flour (parts | | | | | | | | |
| by mass) | | | | | | | | |
| Hydroxypropylated | 0 | 0 | 0 | 20 | 10 | 5 | 0 | 0 |
| starch (parts | | | | | | | | |
| by mass) | | | | | | | | |
| Regular wheat | 80 | 70 | 60 | 20 | 10 | 5 | 5 | 0 |
| flour (parts | | | | | | | | |
| by mass) | | | | | | | | |
| Amount of coating | 1 | 1 | 1 | 1 | 1 | 1 | 1 | 1 |
| liquid attached | | | | | | | | |
| (parts by mass | | | | | | | | |
| relative to 100 | | | | | | | | |
| parts by mass of | | | | | | | | |
| boiled pasta) | | | | | | | | |
| Appearance of | 3.5 | 4.4 | 4.5 | 4.8 | 4.8 | 4.5 | 4.4 | 4.3 |
| spaghetti | | | | | | | | |
| Texture of | 3.6 | 4.3 | 4.6 | 4.9 | 5.0 | 4.7 | 4.4 | 4.2 |
| spaghetti | | | | | | | | |
| Appearance of | 3.8 | 4.3 | 4.4 | 4.6 | 4.7 | 4.5 | 4.3 | 4.2 |
| spaghetti | | | | | | | | |
| with sauce | | | | | | | | |
| Texture of | 3.3 | 4.0 | 4.4 | 4.9 | 4.9 | 4.5 | 4.4 | 4.3 |
| spaghetti | | | | | | | | |
| with sauce | | | | | | | | |

### Production Example 44

Durum wheat semolina flour (Leone G: Nisshin Flour Milling Inc.) (100 parts by mass) and water (26 parts by mass) were mixed and then kneaded to prepare noodle dough. Under a reduced pressure condition of −600 mmHg, the resulting dough was extruded into spaghetti once (1.8 mm in diameter) using a pasta making machine. Subsequently, the resulting spaghetti was cut into chips 15 mm in length and kneaded again, then put in the pasta making machine, and extruded under a pressure condition of 120 kgf/cm², whereby the fresh spaghetti (1.8 mm in diameter) of Production Example 44 was obtained. The fresh spaghetti thus obtained was boiled in a similar manner to Production Example 25, whereby cooked and frozen spaghetti (with and without sauce) was produced.

Using the cooked and frozen spaghetti of Production Example 44, the appearance and texture of the spaghetti or spaghetti with sauce after being thawed were evaluated by the same procedure as in Test Example 1. The results are shown in Table 8. Also, the results of Production Example 25 are shown again in Table 8. The spaghetti of Production Example 44, which was produced from twice-kneaded dough, was very hard without elasticity, failing in achieving a unique texture of fresh spaghetti.

TABLE 8

| | Produc- | Produc- |
|---|---|---|
| | tion | tion |
| | Example | Example |
| | 25 | 44 |
| Number of extrusion | 1 | 2 |
| Amount of coating liquid | 1 | 1 |
| attached (parts by mass | | |
| relative to 100 parts by | | |
| mass of boiled pasta) | | |
| Appearance of | 4.3 | 4.0 |
| spaghetti | | |
| Texture of | 4.2 | 2.7 |
| spaghetti | | |
| Appearance of | 4.2 | 3.8 |
| spaghetti | | |
| with sauce | | |
| Texture of | 4.3 | 2.3 |
| spaghetti | | |
| with sauce | | |

1. A method for producing cooked and frozen pasta, the method comprising:
boiling fresh pasta obtained by extruding dough into pasta noodles at a pressure of 80 kgf/cm² to 200 kgf/cm² to obtain a boiled pasta;
contacting the boiled pasta with a liquid comprising an oil or a fat having a melting point of 10° C. or less; and
freezing the pasta which has been brought into contact with the liquid comprising an oil or a fat.

2. The method of claim 1, wherein the dough is a dough obtained by adding 18 to 35 parts by mass of a kneading water to 100 parts by mass of a flour ingredient; and
kneading the dough.

3. The method of claim 1, wherein the extrusion is performed at a pressure in the range of −200 mmHg to under vacuum.

4. The method of claim 1, wherein an amount of the liquid comprising an oil or a fat having a melting point of 10° C. or less attaching to the boiled pasta is from 1 to 12 parts by mass relative to 100 parts by mass of the boiled pasta.

5. The method of claim 2, wherein the flour ingredient comprises durum flour and at least one selected from the group consisting of starch, processed starch and regular wheat flour at a blending ratio in the range of 30:70 to 95:5.

6. The method of any one of claim 1-5 or 7-16, wherein the freezing further comprises freezing the pasta with a sauce.

7. The method of claim 2, wherein the extrusion is performed at a pressure in the range of −200 mmHg to under vacuum.

8. The method of claim 2, wherein an amount of the liquid comprising an oil or fat having a melting point of 10° C. or less attaching to the boiled pasta is in the range of 1 to 12 parts by mass relative to 100 parts by mass of the boiled pasta.

9. The method of claim 3, wherein an amount of the liquid comprising an oil or fat having a melting point of 10° C. or less attaching to the boiled pasta is in the range of 1 to 12 parts by mass relative to 100 parts by mass of the boiled pasta.

10. The method of claim 7, wherein an amount of the liquid comprising an oil or fat having a melting point of 10° C. or less attaching to the boiled pasta is in the range of 1 to 12 parts by mass relative to 100 parts by mass of the boiled pasta.

11. The method of claim 3, wherein the flour ingredient comprises durum flour and at least one selected from the group consisting of starch, processed starch and regular wheat flour at a blending ratio of 30:70 to 95:5.

12. The method of claim 4, wherein the flour ingredient comprises durum flour and at least one selected from the group consisting of starch, processed starch and regular wheat flour at a blending ratio of 30:70 to 95:5.

13. The method of claim 7, wherein the flour ingredient comprises durum flour and at least one selected from the group consisting of starch, processed starch and regular wheat flour at a blending ratio of 30:70 to 95:5.

14. The method of claim 8, wherein the flour ingredient comprises durum flour and at least one selected from the group consisting of starch, processed starch and regular wheat flour at a blending ratio of 30:70 to 95:5.

15. The method of claim 9, wherein the flour ingredient comprises durum flour and at least one selected from the group consisting of starch, processed starch and regular wheat flour at a blending ratio of 30:70 to 95:5.

16. The method of claim 10, wherein the flour ingredient comprises durum flour and at least one selected from the group consisting of starch, processed starch and regular wheat flour at a blending ratio of 30:70 to 95:5.

17. (canceled)
